(19) United States
(12) Patent Application Publication
(10) Pub. No.: US 2026/0233532 A1
(43) Pub. Date: Aug. 13, 2026

(54) DEGASSING DEVICE AND INKJET RECORDING APPARATUS

(71) Applicant: KYOCERA Document Solutions Inc., Osaka (JP)

(72) Inventors: Hiroaki WATANABE, Osaka-shi, Osaka (JP); Yoshihiro YAMAGISHI, Osaka-shi, Osaka (JP); Hideki ISHIDA, Osaka-shi, Osaka (JP); Takeru YOSHIDA, Osaka-shi, Osaka (JP)

(73) Assignee: KYOCERA Document Solutions Inc., Osaka (JP)

(21) Appl. No.: 19/469,366

(22) PCT Filed: May 16, 2024
(86) PCT No.: PCT/JP2024/018068

§ 371 Date: Sep. 25, 2025

(30) Foreign Application Priority Data
Mar. 29, 2023 (JP) 2023-053963

(51) Int. Cl. B41J 2/19; B41J 2/165; B41J 2/175; B41J 2/18

(52) U.S. Cl. CPC B41J 2/19; B41J 2/16505; B41J 2/17596; B41J 2/18

(57) ABSTRACT

A degassing device (40) a removes air dissolved in a liquid under a reduced pressure atmosphere. The degassing device (40) includes a liquid tank (32) in which the liquid is stored; a pressure reducing device (80) which reduces pressure of the liquid tank (32); a circulation flow path (47) which connects different positions of the liquid tank (32); and a circulation pump (67) which circulates the liquid through the circulation flow path (47). The pressure reducing device (80) includes a pressure reducing tank (81) connected to the liquid tank (32); a first pressure reducing valve (521) provided between the liquid tank (32) and the pressure reducing tank (81); and a pressure reducing pump (62) which reduces pressure in the pressure reducing tank (81).

### TECHNICAL FIELD

The present invention relates to a degassing device, an inkjet recording apparatus and a degassing method.

### BACKGROUND

In an inkjet recording apparatus, when an amount of dissolved air of ink increases, bubbles may be generated inside a recording head, resulting in ejection failure. Therefore, a technique for reducing the amount of dissolved air in the ink has been studied. As an example, there is known a configuration in which the ink is degassed by reducing pressure in the ink tank. For example, Patent Document 1 discloses a configuration using a degassing module. Patent Document 2 discloses a configuration having a buffer tank for accumulating reduced pressure and increased pressure.

### PRIOR ART DOCUMENTS

### Patent Document

Patent Document 1: Japanese Patent Laid-Open No. 2014-83741
Patent Document 2: Japanese Patent Laid-Open No. 2015-58656

### SUMMARY OF THE INVENTION

### Problems to be Solved by Invention

However, the configuration disclosed in Patent Document 1 requires periodic replacement of the filter in addition to the high cost. In addition, in the configuration disclosed in Patent Document 2, when the pressurization cleaning in which bubbles or the like are discharged by pressurization is not performed, the buffer tank for pressurization is unnecessary, which leads to an increase in the size and cost of the apparatus.

It is an object of the present invention to provide a degassing device capable of performing degassing efficiently with a simple structure and an inkjet recording apparatus.

### Means of Solving the Problems

A degassing device according to the present invention removes air dissolved in a liquid under a reduced pressure atmosphere. The degassing device includes a liquid tank in which the liquid is stored; a pressure reducing device which reduces pressure of the liquid tank; a circulation flow path which connects different positions of the liquid tank; and a circulation pump which circulates the liquid through the circulation flow path. The pressure reducing device includes a pressure reducing tank connected to the liquid tank; a first pressure reducing valve provided between the liquid tank and the pressure reducing tank; and a pressure reducing pump which reduces pressure in the pressure reducing tank.

An inkjet recording apparatus according to the present invention includes the degassing device and a recording head which ejects a degassed ink as the liquid to a sheet.

### Effects of the Invention

According to the present invention, it becomes possible to perform degassing efficiently with a simple structure.

### BRIEF DESCRIPTION OF DRAWINGS

FIG. 1 is a schematic view showing an inkjet recording apparatus according to one embodiment of the present invention.

FIG. 2 is a schematic view showing an ink supply structure according to the embodiment of the present invention.

FIG. 3 is a schematic view showing a circulation pump according to the embodiment of the present invention.

FIG. 4 is a flow diagram showing an overall operation of a degassing device according to the embodiment of the present invention.

FIG. 5 is a flow diagram showing an operation of a negative pressure accumulation process of the degassing device according to the embodiment of the present invention.

FIG. 6 is a flow diagram showing an operation of a pressure reducing process of the degassing device according to the embodiment of the present invention.

FIG. 7 is a flow diagram showing an operation of a degassing process of the degassing device according to the embodiment of the present invention.

FIG. 8 is a view showing the result of performing a circulation degassing in the present embodiment and the conventional configuration.

FIG. 9 shows the results of estimating a pressure in an upper space using a pressure and a volume ratio of the pressure reducing tank as parameters.

FIG. 10 is a schematic view showing a modified example of the ink supply structure according to the embodiment of the present invention.

### EMBODIMENT FOR CARRYING OUT THE INVENTION

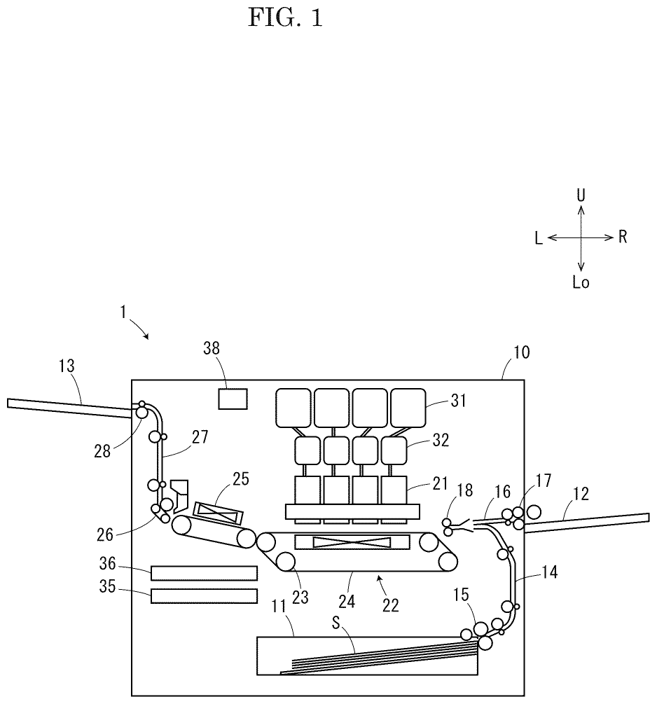

Hereinafter, with reference to the drawings, an inkjet recording apparatus 1 of the present embodiment will be described. FIG. 1 is a schematic view showing the inkjet recording apparatus 1. For convenience of explanation, the front side of the paper surface on which FIG. 1 is drawn is defined as the front side of the inkjet recording apparatus 1, and the left-and-right direction will be described with reference to the direction in which the inkjet recording apparatus 1 is viewed from the front side. The arrows L, R, U, and Lo attached to each figure indicate the left, right, upper, and lower sides of the inkjet recording apparatus 1, respectively.

As shown in FIG. 1, the inkjet recording apparatus 1 is formed so as to perform printing by ejecting ink (an example of the liquid) from each inkjet recording head 21 toward a sheet S as a recording medium. The inkjet recording apparatus 1 includes a box-shaped housing 10 in which various devices are housed. A sheet feeding cassette 11 in which the sheet S is set is housed in the lower portion of the housing 10, and a manual sheet feeding tray 12 on which the sheet S is set by hand is installed on the right side surface of the housing 10. On the upper portion of the left side surface of the housing 10, a sheet discharge tray 13 on which the recorded sheet S is loaded is installed.

In the right side portion in the housing 10, a first conveyance path 14 along which the sheet S is conveyed from the sheet feeding cassette 11 to the recording head 21 provided in the center of the housing 10 is formed. On the upstream side of the first conveyance path 14, a first sheet feeding part 15 which feeds the sheet S from the sheet bundle in the sheet feeding cassette 11 is provided, and a pair of registration rollers 18 which adjusts a feeding timing of the sheet S is provided in the downstream portion of the first conveyance path 14. Further, a sheet feeding path 16 extending from the manual sheet feeding tray 12 is merged with the downstream portion of the first conveyance path 14, and a second sheet feeding part 17 which feeds the sheet S from the sheet bundle on the manual sheet feeding tray 12 is provided on the sheet feeding path 16.

On the downstream side of the pair of registration rollers 18, a conveying device 22 and the recording head 21 provided for each color (for example, black, cyan, magenta, and yellow) are installed. The pair of registration rollers 18 corrects the skew of the sheet S, and then sends the sheet S to the conveying device 22 in accordance with an ink ejecting operation by each recording head 21. In the housing 10, an ink container 31 and an ink tank 32 are provided for each recording head 21. The ink of each ink container 31 is temporarily stored in the ink tank 32, the ink is degassed as necessary, and then the ink is supplied from the ink tank 32 to the recording head 21.

The conveying device 22 is constituted by winding a conveyance belt 24 around a plurality of tension rollers 23 installed below the recording heads 21. On the downstream side of the conveying device 22, a drying device 25 which dries the ink on the sheet S is provided. On the downstream side of the drying device 25, a decurl device 26 which corrects a curl generated on the sheet S by drying the ink is provided. On the downstream side of the decurl device 26, a second conveyance path 27 along which the sheet S is conveyed toward the sheet discharge tray 13 is formed. In the downstream portion of the second conveyance path 27, a sheet discharge part 28 which discharges the recorded sheet S to the sheet discharge tray 13 is provided.

Below the drying device 25, a maintenance unit 35 which cleans the recording heads 21 and a cap unit 36 which caps the recording heads 21 are provided. The maintenance unit 35 is provided with a squeegee-shaped wiping blade, and the wiping blade scrapes the ink remaining on the nozzle surface of the recording head 21. The cap unit 36 is provided with a head cap, and the nozzle surface of the recording head 21 is capped with the head cap. The head cap suppresses drying of the ink in the nozzle. The drying of the ink in the nozzle may be further suppressed by storing a liquid such as a cleaning liquid in the head cap.

Further, the inkjet recording apparatus 1 is provided with a control device 38 for controlling the entire apparatus. The control device 38 may be constituted by a processor or a logic circuit (hardware) formed in an integrated circuit or the like. In the case of a processor, the processor reads and executes a program stored in a memory, and various processes are executed. For example, a CPU (Central Processing Unit) is used as the processor. The memory is constituted by one or more storage devices such as a ROM (Read Only Memory), a RAM (Random Access Memory) or the like depending on the application.

At the time of image recording (printing), the sheet S is fed from the sheet feeding cassette 11 or the manual sheet feeding tray 12 by the first sheet feeding part 15 or the second sheet feeding part 17, respectively, and then sent to the pair of registration rollers 18. In accordance with the ejecting timing of the ink, the sheet S is conveyed from the pair of registration rollers 18 to the conveyance belt 24, the degassed ink is ejected from each recording head 21, and a color image is recorded on the surface of the sheet S. The sheet S is dried by the drying device 25, and the curl of the sheet S is corrected by the decurl device 26. The sheet S is conveyed to the sheet discharge part 28 through the second conveyance path 27, and the recorded (printed) sheet S is discharged to the sheet discharge tray 13 by the sheet discharge part 28.

By the way, the liquid surface of the ink comes into contact with air in the ink tank 32, and the dissolving of the air proceeds, and the nozzle of the recording head 21 may be clogged by bubbles in the ink. Therefore, it is desired to appropriately keep an amount of dissolved gas in the ink. For example, a method has been proposed in which by passing the ink through the hollow fiber filter in a state where the pressure of the circumference of the hollow fiber filter is reduced, the air is moved from the wall surface of the hollow fiber to the pressure decreased side to degas the ink. This method requires the expensive hollow fiber filter and requires periodic replacement operations, which increase cost.

In order to prevent the clogging of the nozzle, a system (hereinafter referred to as a stirring degassing system) has been proposed in which the ink is stirred by a stirrer in a state in which the pressure in the ink tank 32 is reduced below an atmospheric pressure to degas the ink. In the stirring degassing system, a magnetic force is applied to the stirrer in the ink tank 32 from the outside, and the stirrer is rotated by the magnetic force to stir the ink in the ink tank 32. When the depth of the ink and the tank diameter are large, the ink is difficult to be stirred, and the degassing efficiency is lowered. As the rotational speed of the stirrer is increased, the ink is easily stirred, but when the rotational speed of the stirrer becomes too high, a loss of synchronization occurs and the rotational sound of the stirrer becomes large.

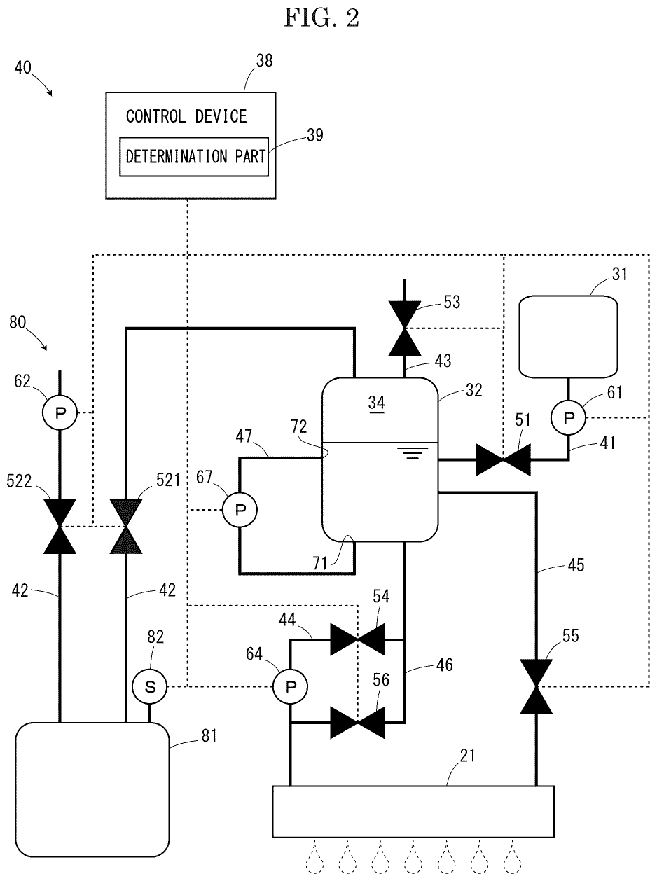

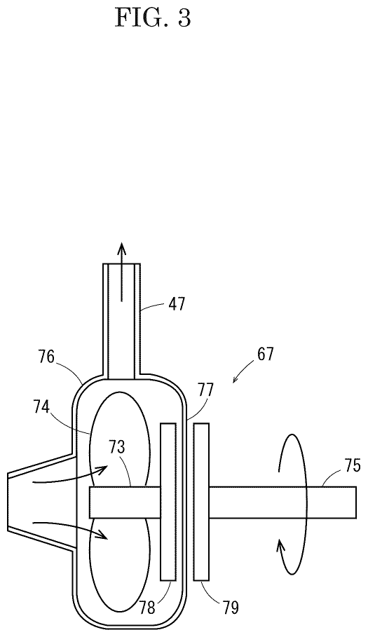

Therefore, in the present embodiment, a system (hereinafter referred to as a circulation degassing system) is adopted in which the ink in the ink tank 32 is circulated through a circulation flow path 47 and degassed while the pressure in the ink tank 32 is reduced to an atmospheric pressure or lower (see FIG. 2). In the circulation degassing system, since the ink circulates in the circulation flow path 47 and the ink tank 32, the ink near the liquid surface where an amount of dissolved air is small is replaced with the ink near the bottom surface where an amount of dissolved air is large, thereby improving the degassing efficiency. Unlike the stirring degassing system, it is not affected by the depth of the ink or the tank diameter, and the driving sound of the circulation pump 67 is suppressed rather than the rotational sound of the stirrer, thereby improving the quietness.

[Degassing Device] A degassing device 40 according to the present embodiment will be described. FIG. 2 is a schematic view showing an ink supply structure. FIG. 3 is a schematic view showing a circulation pump 67 according to the present embodiment. Although the inkjet recording apparatus 1 according to the present embodiment is provided with the ink supply structure for each color, one ink supply structure will be described here.

The degassing device 40 according to the present embodiment is the degassing device 40 which removes air dissolved in a liquid under a reduced pressure atmosphere, and includes the ink tank 32 (an example of the liquid tank) in which the liquid is stored, a pressure reducing device 80 which reduces the pressure of the ink tank 32, a circulation flow path 47 which connects different positions of the ink tank 32, and a circulation pump 67 which circulates the liquid through the circulation flow path 47. The pressure reducing device 80 includes a pressure reducing tank 81 connected to the ink tank 32, a first pressure reducing valve 521 provided between the ink tank 32 and the pressure reducing tank 81, and a pressure reducing pump 62 which reduces the pressure of the pressure reducing tank 81. Details are provided below.

[Replenishment Flow Path] As shown in FIG. 2, the ink tank 32 stores the ink supplied from the ink container 31 through a replenishment flow path 41. In the replenishment flow path 41, a replenishment pump 61 and a replenishment valve 51 are provided, and the replenishment of the ink to the ink tank 32 is controlled by the replenishment pump 61 and the replenishment valve 51.

[Pressure Reducing Flow Path] The upper space 34 of the ink tank 32 is communicated with a pressure reducing flow path 42. In the pressure reducing flow path 42, a pressure reducing tank 81 and a pressure reducing pump 62 which reduce the pressure in the pressure reducing tank 81 are provided. A first pressure reducing valve 521 is provided between the pressure reducing tank 81 and the ink tank 32. A second pressure reducing valve 522 is provided between the pressure reducing tank 81 and the pressure reducing pump 62. The pressure reducing tank 81 is provided with a barometer 82 which measures a pressure in the pressure reducing tank 81. A pressure reducing device 80 is formed by the pressure reducing flow path 42, the pressure reducing tank 81, the pressure reducing pump 62, the first pressure reducing valve 521, the second pressure reducing valve 522, and the barometer 82.

[Atmosphere Opening Flow Path] The upper space 34 of the ink tank 32 is communicated with an atmosphere opening flow path 43. The atmosphere opening flow path 43 is provided with an atmosphere opening valve 53, and the upper space 34 is opened to the atmosphere by the atmosphere opening valve 53.

[Supply Flow Path, Recovery Flow Path, Bypass Flow Path] The ink is supplied from the ink tank 32 to the recording head 21 through a supply flow path 44, and recovered from the recording head 21 to the ink tank 32 through a recovery flow path 45. The supply flow path 44 is provided with a supply pump 64 and a supply valve 54, and the recovery flow path 45 is provided with a recovery valve 55. An ink replacement operation and a bubbles removal operation in the recording head 21 are controlled by the supply pump 64, the supply valve 54 and the recovery valve 55. A bypass flow path 46 bypassing the supply pump 64 is communicated with the supply flow path 44, and a bypass valve 56 is provided in the bypass flow path 46. In the printing, the ink is passed through the bypass flow path 46 by the bypass valve 56.

[Circulation Flow Path] The vicinity of the liquid surface of the ink and the vicinity of the bottom surface of the ink tank 32 communicate with each other through the circulation flow path 47. The circulation flow path 47 is provided with a circulation pump 67, and the ink is circulated through the circulation flow path 47 by the circulation pump 67. An inflow port 72 from the circulation flow path 47 to the ink tank 32 is higher than an outflow port 71 from the ink tank 32 to the circulation flow path 47. Specifically, the outflow port 71 is opened on the bottom surface of the ink tank 32, and the inflow port 72 is opened on the side surface of the ink tank 32 near the liquid surface.

[Circulation Pump] Since the inside of the ink tank 32 is in the reduced pressure state during the degassing operation, a reciprocating pump such as a diaphragm pump is easily affected by the reduced pressure. Therefore, it is preferable that the circulation pump 67 is a pump for feeding the ink by a rotating body. For example, as the circulation pump 67, a non-positive displacement pump such as a centrifugal pump, a diagonal flow pump, an axial flow pump, or a positive displacement rotary pump such as a vane pump, a gear pump, a screw pump, or the like may be used. By using these pumps, unlike the reciprocating pump, the ink can be circulated while suppressing the influence of pressure reduction in the ink tank 32.

In general, the recording head 21 may be included in the middle of the circulation flow path 47 in the circulation degassing system, but in this embodiment, the recording head 21 is not included in the circulation flow path 47. That is, the circulation flow path 47 is provided separately from the flow path for supplying the ink to the recording head 21. Since the recording head 21 is not included in the circulation flow path 47, the possibility that the meniscus formed in the nozzle of the recording head 21 is destroyed by the pressure reducing at the time of degassing and the outside air enters the recording head 21 can be reduced.

As shown in FIG. 3, a power can be transmitted between a pump shaft 73 of the circulation pump 67 and a motor shaft 75 across a partition wall 77 in a non-contact manner. A pump casing 76 is formed in the middle of the circulation flow path 47, and the pump shaft 73 with an impeller 74 is housed in the pump casing 76. A motor (not shown) is provided outside the circulation flow path 47. Disks 78 and 79 are provided at the ends of the pump shaft 73 and the motor shaft 75, and the disks 78 and 79 face each other across the partition wall 77 of the pump casing 76. Magnets (not shown) having S poles and N poles alternately arranged in the circumferential direction are disposed on the opposing surfaces of the disks 78 and 79.

The pump shaft 73 and the motor shaft 75 are magnetically coupled (magnet coupling), and the power is transmitted from the motor shaft 75 to the pump shaft 73 using a magnetic force. The impeller 74 in the pump casing 76 can be rotated while the pump casing 76 is liquid-tightly sealed without penetrating the motor shaft 75 through the pump casing 76. Since the space between the disk 78 of the pump shaft 73 and the disk 79 of the motor shaft 75 is partitioned by the partition wall 77 of the pump casing 76, even if a pressure difference occurs between the inside and the outside of the pump casing 76 when the pressure in the ink tank 32 is reduced, ink leakage caused by the pressure difference is surely prevented.

[Control Device] The replenishment pump 61, the pressure reducing pump 62, the supply pump 64, the circulation pump 67, the replenishment valve 51, the first pressure reducing valve 521, the second pressure reducing valve 522, the atmosphere opening valve 53, the supply valve 54, the recovery valve 55, and the bypass valve 56 are controlled by the control device 38. The control device 38 is provided with a determination part 39 which determines whether the degassing operation is necessary in accordance with an ink standing time. When the determination part 39 determines that the degassing of the ink is unnecessary, the degassing operation is regulated. Even if the air is re-dissolved by leaving the ink, the ink can be used without the degassing within an allowable time. The details of the determination process executed by the determination part 39 will be described later. In the ink supply structure of the inkjet recording apparatus 1, the degassing device 40 is formed by the ink tank 32, the pressure reducing flow path 42, the pressure reducing pump 62, the pressure reducing valve 52, the circulation flow path 47, the circulation pump 67, the determination part 39, and the others.

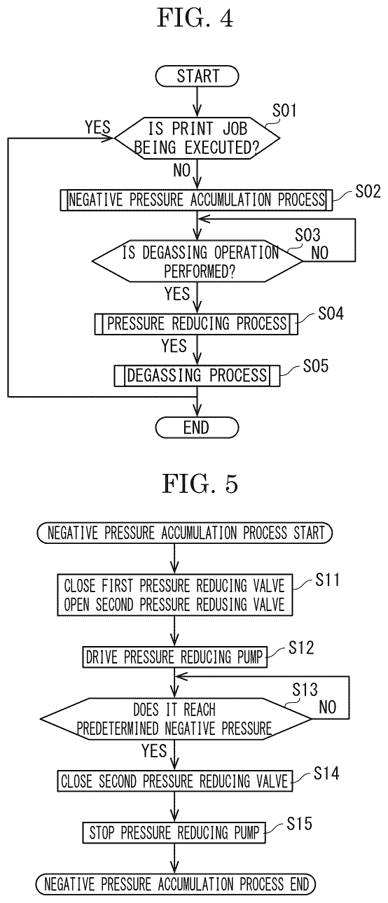

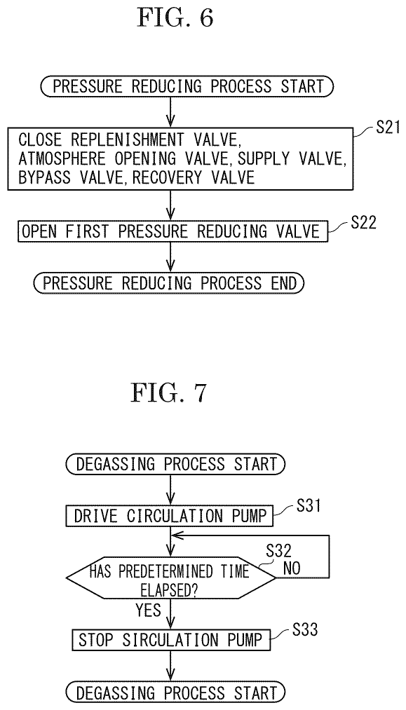

Next, the operation of the degassing device 40 will be described. FIG. 4 is a flow diagram showing the overall operation of the degassing device 40. FIG. 5 is a flow diagram showing an operation of a negative pressure accumulation process of the degassing device 40. FIG. 6 is a flow diagram showing an operation of a pressure reducing process of the degassing device 40. FIG. 7 is a flow diagram showing an operation of a degassing process of the degassing device 40.

Here, the standby state is described as an initial state. In the standby state, the replenishment valve 51, the pressure reducing valve 52, and the supply valve 54 are closed, and the atmosphere opening valve 53, the bypass valve 56, and the recovery valve 55 are opened. The ink is stored in the ink tank 32, and when the liquid surface comes into contact with the air in the upper space 34 opened to the atmosphere, the air is dissolved in the ink with the passage of time. In the standby state, the control device 38 periodically repeats the operation shown in FIG. 4.

First, the control device 38 determines whether a print job is being executed (FIG. 4, step S01). If the print job is being executed (step S01: YES), the control device 38 ends the process shown in FIG. 4. On the other hand, if the print job is not being executed (step S01: NO), the control device 38 executes the negative pressure accumulation process (step S02).

[Negative Pressure Accumulation Process] In the negative pressure accumulation process (see FIG. 5), the control device 38 closes the first pressure reducing valve 521 and opens the second pressure reducing valve 522 (step 11). Next, the control device 38 drives the pressure reducing pump 62 to reduce the pressure in the pressure reducing tank 81 (step 12), and determines whether the atmospheric pressure in the pressure reducing tank 81 indicated by the barometer 82 reaches a predetermined negative pressure (step 13). If it is determined that the atmospheric pressure does not reach the predetermined negative pressure (NO in step S13), the control device 38 repeats the determination in step S13 while driving the pressure reducing pump 62. On the other hand, if it is determined that the atmospheric pressure reaches the predetermined negative pressure (YES in step S13), the control device 38 closes the second pressure reducing valve 522 (step S14) and stops the pressure reducing pump 62 (step S15).

Next, the determination part 39 of the control device 38 determines whether the degassing is performed (FIG. 4, step S03). For example, the control device 38 (see FIG. 2) is provided with a timer, and the ink standing time is measured by the timer. The amount of dissolved air of the ink can be estimated from one or more parameters such as an atmospheric pressure, a temperature of the ink, and an elapsed time since the last printing. Therefore, conversion information indicating a correspondence between each parameter and the amount of dissolved air of the ink is stored in the determination part 39, and the amount of dissolved air of the ink is estimated based on each parameter. Further, conversion information indicating a correspondence between an amount of dissolved air of the ink and an allowable time is stored in the determination part 39, and the allowable time is set based on the amount of dissolved air of the ink. The allowable time is a time during which the printing is allowed without degassing even if the ink is left unattended.

When the standing time of the ink is within the allowable time, the determination part 39 determines that the degassing is unnecessary because the oxygen saturation is low, and the degassing operation is restricted. When the standing time of the ink exceeds the allowable time, the determination part 39 determines that the degassing is necessary because the oxygen saturation is high, and the degassing operation is performed. Map data, a lookup table, a conversion formula, or the like are used as the conversion information indicating the correspondence between each parameter and the viscosity of the ink, and the conversion information indicating the correspondence between the viscosity of the ink and the allowable time. These map data, lookup tables, and conversion formulas are obtained experimentally, empirically, and theoretically in advance.

If it is determined in step S03 that the degassing is not to be performed (step S03: NO), the control device 38 repeats the determination in step S03. On the other hand, if it is determined that the degassing is to be performed (step S03: YES), the control device 38 performs the pressure reducing process (step S04).

[Pressure Reducing Process] In the pressure reducing process (see FIG. 6), the control device 38 closes the replenishment valve 51, the atmosphere opening valve 53, the supply valve 54, the bypass valve 56, and the recovery valve 55 (step S21), and opens the first pressure reducing valve 521 (step S22). Then, air flows into the pressure reducing tank 81 from the upper space 34 of the ink tank 32 to reduce the pressure of the upper space 34, and the pressure of the pressure reducing tank 81 becomes equal to the pressure of the upper space 34.

[Degassing Process] When the pressure reducing process is completed, the control device 38 performs the degassing process (FIG. 4, step S05). In the degassing process (see FIG. 7), the control device 38 drives the circulation pump 67 (step 31). When the circulation pump 67 is driven, the ink in the ink tank 32 is circulated through the circulation flow path 47. The ink near the bottom surface of the ink tank 32 where an amount of dissolved air is large flows out to the circulation flow path 47 through the outflow port 71, and the ink in the circulation flow path 47 flows into the vicinity of the liquid surface in the ink tank 32 through the inflow port 72. The liquid surface of the ink is exposed to the reduced pressure atmosphere to remove the air dissolved in the ink near the liquid surface. The ink near the liquid surface where an amount of dissolved air is small is smoothly replaced with the ink near the bottom surface where an amount of dissolved air is large, so that the degassing efficiency is improved.

Next, the control device 38 determines whether a predetermined time elapses since the start of driving the circulation pump 67 (step 32). If it is determined that the predetermined time does not elapse (NO in step S32), the control device 38 repeats the determination in step S32 while driving the circulation pump 67. On the other hand, if it is determined that the predetermined time elapses (YES in step S32), the control device 38 stops the circulation pump 67 (step S33).

[Replacement Process] When the ink in the recording head 21 is replaced, the replenishment valve 51, the first pressure reducing valve 521, and the bypass valve 56 are closed, and the atmosphere opening valve 53, the supply valve 54, and the recovery valve 55 are opened. The supply pump 64 is driven to supply the ink from the ink tank 32 to the recording head 21 through the supply flow path 44, and the ink is recovered from the recording head 21 to the ink tank 32 through the recovery flow path 45. By circulating the ink between the recording head 21 and the ink tank 32, the ink having an increased viscosity in the recording head 21 is replaced and bubbles are removed from the recording head 21.

<Printing Process> At the time of printing operation by the recording head 21, the replenishment valve 51, the first pressure reducing valve 52, and the supply valve 54 are closed, and the atmosphere opening valve 53, the bypass valve 56 and the recovery valve 55 are opened. That is, during the printing operation, the ink tank 32 is opened into the atmosphere, and is at atmospheric pressure. During the printing operation, the ink tank 32 is not reduced in pressure to the extent that substantial degassing occurs. Every time the ink is ejected from the recording head 21, the ink is supplied from the ink tank 32 to the recording head 21 through the bypass flow path 46 and the recovery flow path 45. The ink may be replenished in the middle of the ink replacement operation and the printing operation. At the ink replenishment operation, the replenishment valve 51 is opened, and the replenishment pump 61 is driven. By the driving the replenishment pump 61, the ink is replenished from the ink container 31 to the ink tank 32 through the replenishment flow path 41.

FIG. 1 and the others are schematically drawn, and the recording head 21 is actually disposed above the ink tank 32. A negative pressure is applied to the ink in the recording head 21 by a head difference from the ink in the ink tank 32, and a meniscus is formed in the nozzle of the recording head 21 by the negative pressure. After the ink is ejected from the recording head 21, the surface tension of the ink acts to reduce the surface area of the meniscus, and the resulting negative pressure draws the reduced amount of the ink from the ink tank 32 into the recording head 21. The recovery valve 55 may be closed to supply the ink to the recording head 21 only from the bypass flow path 46.

If the pressure in the ink tank 32 is reduced to the extent that substantial degassing occurs in a state where the recording head 21 and the ink tank 32 are connected, the meniscus of the nozzle may be destroyed. Even if the meniscus is not destroyed, there is a risk that the shape of the meniscus in the nozzle is changed compared with the case where the ink tank 32 is released to the atmosphere, and the ejecting characteristic of the ink is changed. In the present embodiment, since the pressure in the ink tank 32 is not reduced so as not to cause substantial degassing during the printing operation, the meniscus in the nozzle of the recording head 21 is not destroyed, and since its shape is not changed, the ejection characteristic is not changed.

### Comparison with Conventional Example

Next, a comparison between the present embodiment and a conventional configuration will be described. The conventional configuration is a configuration in which the pressure reducing tank 81 and the second pressure reducing valve 522 are not provided and the upper space 34 is directly reduced in pressure by the pressure reducing pump 62.

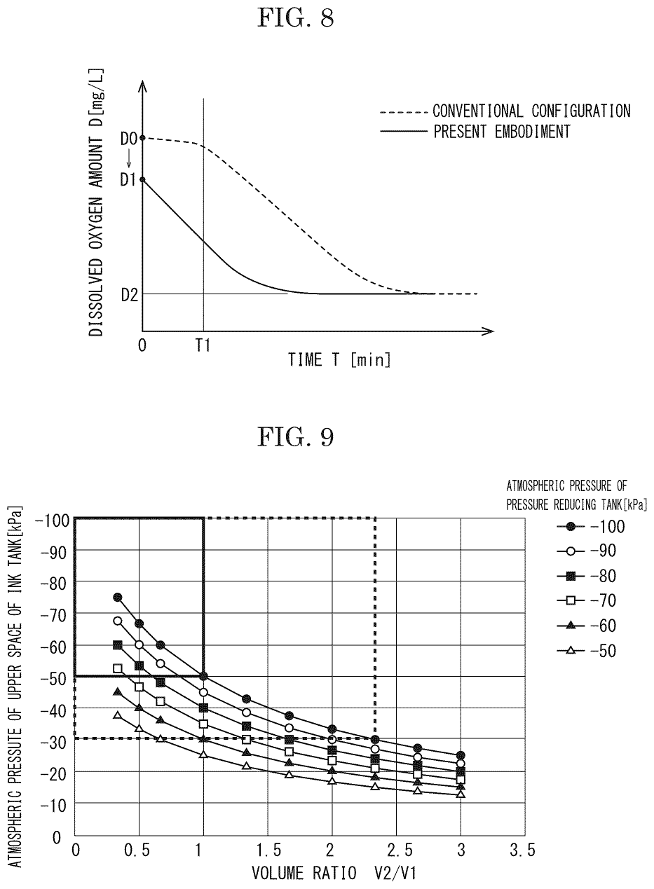

FIG. 8 is a diagram showing the result of performing the circulation degassing in this embodiment and the conventional configuration. The viscosity of the ink was 7 [mPa·s], the temperature of the ink was 25 [° C.], the tank diameter of the ink tank 32 was 60 [mm], the depth of the ink was 28 [mm], and the circulating flow rate of the ink was 770 [ml/min], and the change of the amount of dissolved oxygen D with time was compared. The initial value of the amount of dissolved oxygen D is DO [mg/L].

In the present embodiment (the solid line), after the negative pressure accumulation process was performed in advance, the circulation degassing was started together with the pressure reducing process at time T=0 [min], and a time until the amount of dissolved oxygen D converged to D2 [mg/L] was measured. On the other hand, in the conventional configuration (the broken line), the pressure reducing pump 62 was started to be driven at time T=0 [min], the first pressure reducing valve 521 was opened at the time when the pressure in the ink tank 32 reached a predetermined atmospheric pressure to start the circulation degassing (time T=T1 [min]), and a time until the amount of dissolved oxygen D converged to D2 [mg/L] was measured.

As shown in FIG. 8, in this embodiment, the degassing can be performed in a shorter time than in the conventional configuration. This is because in the present embodiment, since the negative pressure accumulation process is performed in advance, the dissolved gas is discharged as bubbles when the pressure reducing process is started, and the amount of dissolved oxygen D is instantly reduced to D1 [mg/L], whereas in the conventional configuration, it requires a certain period of time (in the example shown in FIG. 8, T1 [min]) until the pressure in the ink tank 32 is sufficiently reduced. That is, in the conventional configuration, it is necessary to decrease the amount of dissolved oxygen D from D0 to D2 in the degassing process, whereas in the present embodiment, the amount of dissolved oxygen D can be substantially decreased from D1 to D2, so that the time required for degassing can be naturally shortened.

[Volume Ratio of Pressure Reducing Tank to Upper Space] Since the pressure reducing condition of the ink tank 32 is related to the degassing performance, the effect of changing the pressure reducing condition in the circulation degassing system on an oxygen saturation and an image quality was confirmed. The viscosity of the ink was 7 [mPa·s], the temperature of the ink was 25 [° C.], the tank diameter of the ink tank 32 was 60 [mm], the depth of the ink was 28 [mm] and the circulation flow rate of the ink was 770 [ml/min], and the pressure reducing condition was changed gradually from 0 [kPa] to −90 [kPa]. The degassing performance was confirmed after 30 minutes when the progress of degassing started to slow down. As shown in Table 1, the degassing performance is obtained when the pressure is reduced to −30 kPa or less, and it is desirable that the pressure is reduced to −50 kPa or less.

### [Image Quality Evaluation Criteria]

The image quality was evaluated according to the following criteria based on the number of pins in which ejecting defects such as slippage and misregistration occurred on a single line printed by the line head of about 2000 pins.
O: No slippage or misregistration.
Δ: The number of pins causing slippage or misregistration was 1 pin or more and 10 pins or less.
x: The number of pins causing slippage or misdirection was 10 or more.

It should be noted that this evaluation criteria is one indicator, and x does not indicate that it is not suitable for practical use.

TABLE 1

| PRESSURE REDUCING | OXYGEN SATURATION | IMAGE |
|---|---|---|
| CONDITION [kPa] | [%] | QUALITY |
| 0 | 100.0 | x |
| −10 | 89.0 | x |
| −20 | 80.8 | x |
| −30 | 72.8 | Δ |
| −40 | 65.0 | Δ |
| −50 | 58.2 | ∘ |
| −60 | 53.5 | ∘ |
| −70 | 47.7 | ∘ |
| −80 | 39.7 | ∘ |
| −90 | 31.9 | ∘ |

Based on the above knowledge, the result of the consideration on the volume ratio of the pressure reducing tank 81 to the upper space 34 of the ink tank 32 will be discussed below. Assuming that the volume of the pressure reducing tank 81 is V1 and the volume of the upper space 34 is V2, when the first pressure reducing valve 521 is opened in the pressure reducing process, the pressure of the entire system is reduced to V1/(V1+V2) relative to the atmospheric pressure of the pressure reducing tank 81 before the first pressure reducing valve 521 is opened.

FIG. 9 shows the result of estimating the atmospheric pressure in the upper space 34 using the atmospheric pressure in the pressure reducing tank 81 and the volume ratio V2/V1 as parameters. In order to reduce the pressure in the upper space 34 to be −30 [kPa] or less, it is necessary that V2/V1 be 7/3 or less. Further, in order reduce the atmospheric pressure in the upper space 34 to be −50 [kPa] or less, it is necessary that V2/V1 be 1 or less.

The degassing device 40 according to the present embodiment described above is a degassing device 40 which removes air dissolved in the liquid under the reduced pressure atmosphere, and includes the ink tank 32 (an example of the liquid tank) in which the liquid is stored, the pressure reducing device 80 which reduces the pressure of the ink tank 32, the circulation flow path 47 which connects different positions of the ink tank 32, and the circulation pump 67 which circulates the liquid through the circulation flow path 47. The pressure reducing device 80 includes the pressure reducing tank 81 connected to the ink tank 32, the first pressure reducing valve 521 provided between the ink tank 32 and the pressure reducing tank 81, and the pressure reducing pump 62 which reduces the pressure of the pressure reducing tank 81. According to this configuration, the pressure reducing tank 81 is reduced in pressure by closing the first pressure reducing valve 521 and driving the pressure reducing pump 62. After the pressure reducing tank 81 is reduced in pressure, the first pressure reducing valve 521 is opened to reduce the pressure in the ink tank 32. By reducing the pressure in the pressure reducing tank 81 beforehand, the liquid tank can be reduced in pressure in a short time before starting the degassing. Since the ink tank 32 is rapidly reduced in pressure by opening the first pressure reducing valve 521, the dissolved gas is discharged as bubbles, and the degassing efficiency can be improved. Therefore, according to the present embodiment, the degassing efficiency can be improved with a simple configuration even if the liquid capacity is large.

According to the degassing device 40 according to the present embodiment, the volume ratio V2/V1 of the volume V2 of the upper space 34 above the liquid surface of the ink tank 32 to the volume V1 of the pressure reducing tank 81 is 7/3 or less. According to this configuration, the atmospheric pressure of the upper space 34 is reduced to −30 [kPa] or less, so that the degassing performance can be obtained.

According to the degassing device 40 according to the present embodiment, the volume ratio V2/V1 is 1 or less. According to this configuration, since the pressure of the upper space 34 is reduced to −50 [kPa] or less, good degassing performance can be obtained.

According to the degassing device 40 according to the present embodiment, the second pressure reducing valve 522 is provided between the pressure reducing pump 62 and the pressure reducing tank 81. According to this configuration, the reduced pressure state can be maintained even when the pressure reducing pump 62 is stopped by closing the second pressure reducing valve 522 after the pressure reducing tank 81 is reduced in pressure.

The inkjet recording apparatus 1 according to the present embodiment includes the degassing device 40 and the recording head 21 for ejecting the degassed ink as the liquid onto the sheet S. According to this configuration, degradation of image quality can be suppressed when a large number of images are formed.

The above embodiments may be modified as follows.

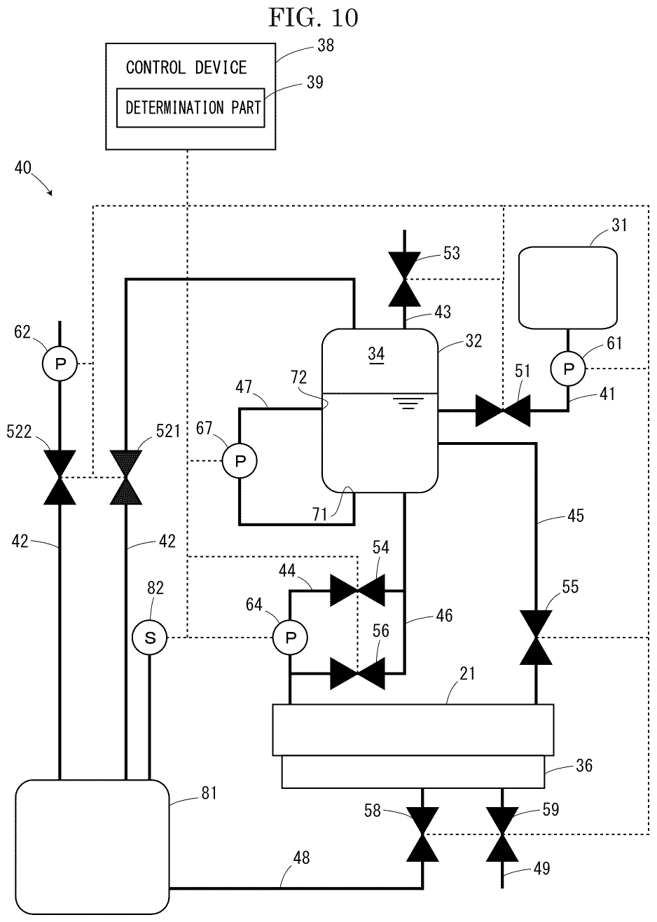

FIG. 10 is a schematic view showing a modified example of the ink supply structure according to the above embodiment. In addition to the configuration of the above-described embodiment, the present modified example includes a cap pressure reducing flow path 48 communicating with the cap unit 36 and the pressure reducing tank 81, and a cap atmosphere opening flow path 49 communicating with the cap unit 36. The cap pressure reducing flow path 48 is provided with a cap pressure reducing valve 58. The cap atmosphere opening flow path 49 is provided with a cap atmosphere opening valve 59. By closing the first pressure reducing valve 521, opening the cap pressure reducing valve 58, the cap atmosphere opening valve 59, and the second pressure reducing valve 522, and driving the pressure reducing pump 62, a reduced pressure cleaning for discharging the ink by pressure reducing the nozzle surface can be performed.

1. A degassing device which removes air dissolved in a liquid under a reduced pressure atmosphere, the degassing device comprising:
a liquid tank in which the liquid is stored;
a pressure reducing device which reduces pressure of the liquid tank;
a circulation flow path which connects different positions of the liquid tank; and
a circulation pump which circulates the liquid through the circulation flow path, wherein
the pressure reducing device includes:
a pressure reducing tank connected to the liquid tank;
a first pressure reducing valve provided between the liquid tank and the pressure reducing tank; and
a pressure reducing pump which reduces pressure in the pressure reducing tank.

2. The degassing device according to claim 1, wherein
a volume ratio V2/V1 of a volume V2 of an upper space above a liquid surface of the liquid tank to a volume V1 of the pressure reducing tank is 7/3 or less.

3. The degassing device according to claim 2, wherein
the volume ratio V2/V1 is 1 or less.

4. The degassing device according to claim 1, wherein
a second degassing valve is provided between the pressure reducing pump and the pressure reducing tank.

5. An inkjet recording apparatus comprising:
the degassing device according to claim 1; and
a recording head which ejects degassed ink as the liquid onto a sheet.

6. The inkjet recording apparatus according to claim 5, comprising:
a cap unit attached to a nozzle surface of the recording head, wherein
the pressure reducing tank is connected to the cap unit.
